(19) United States
(12) Patent Application Publication
(10) Pub. No.: US 2026/0342395 A1
(43) Pub. Date: Oct. 29, 2026

(54) NEURAL NETWORK ARCHITECTURE FOR CSI FEEDBACK

(71) Applicant: APPLE INC., Cupertino, CA (US)

(72) Inventors: Weidong Yang, San Diego, CA (US); Dawei Zhang, Saratoga, CA (US); Haitong Sun, Cupertino, CA (US); Wei Zeng, San Diego, CA (US); Oghenekome Oteri, San Diego, CA (US); Seyed Ali Akbar Fakoorian, San Diego, CA (US)

(21) Appl. No.: 19/107,121

(22) PCT Filed: Sep. 11, 2023
(86) PCT No.: PCT/US2023/073849

§ 371 Date: Feb. 27, 2025

Related U.S. Application Data
(60) Provisional application No. 63/376,808, filed on Sep. 23, 2022.

(51) Int. Cl. H04B 7/06; G06N 3/08; H04L 41/16

(52) U.S. Cl. CPC H04B 7/0626; G06N 3/08; H04L 41/16

(57) ABSTRACT

Methods and apparatus are provided for machine learning (ML) based channel state information (CSI) feedback from a user equipment (UE) to a wireless network. For one or more neural network (NN) model type, the UE sends UE capability signaling to the wireless network to report one or more 3D or 4D input data format to a CSI feedback encoder. For the one or more NN model type, the UE processes NN model configuration information from the wireless network. The UE then generates CSI feedback by providing downlink (DL) channel data or a DL precoder, formatted according to the one or more 3D or 4D input format, to an NN model corresponding to the NN model configuration information. The UE then sends the CSI feedback to the wireless network.

### TECHNICAL FIELD

This application relates generally to wireless communication systems, including channel state information (CSI) feedback.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an encoder and a decoder in a CSI feedback operation according to certain embodiments.

FIG. 2 illustrates an antenna configuration that may be used, for example, at a base station according to certain embodiments.

FIG. 3 illustrates different dimensions of input data for various neural network model types according to certain embodiments.

FIG. 4 is a block diagram illustrating an example 3D convolutional neural network auto encoder that may be used according to certain embodiments.

FIG. 5 is a flowchart illustrating a method for machine learning based CSI feedback according to certain embodiments.

FIG. 6 is a flowchart of a method for a UE to provide machine learning based CSI to a wireless network according to one embodiment.

FIG. 7 is a flowchart of a method for a base station to configure a UE with one or more neural network model for CSI feedback according to one embodiment.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Downlink channel state information (CSI) (e.g., for frequency division duplex (FDD) operation) may be sent from a UE to a base station through feedback channels. The base station may use the CSI feedback, for example, to reduce interference and increase throughput for massive multiple-input multiple-output (MIMO) communication. However, such feedback uses excessive overhead. Vector quantization or codebook-based feedback may be used to reduce feedback overhead. The feedback quantities resulting from these approaches, however, are scaled linearly with the number of transmit antennas, which may be difficult when hundreds or thousands of centralized or distributed transmit antennas are used.

Artificial intelligence (AI) and/or machine learning (ML) may be used for CSI feedback enhancement to reduce overhead, improve accuracy, and/or generate predictions. AI and/or ML may also be used, for example, for beam management (e.g., beam prediction in time/spatial domain for overhead and latency reduction and beam selection accuracy improvement) and/or positioning accuracy enhancements.

CSI feedback using AI and/or ML may be formulated as a joint optimization of an encoder and a decoder. See, e.g., Chao-Kai Wen, Wan-Ting Shih, and Shi Jin, “Deep Learning for Massive MIMO CSI Feedback,” IEEE Wireless Communications Letters, Volume 7, Issue 5, October 2018. Since this early paper by Chao-Kai Wen, et al., auto-encoders and many variations have been considered. Image processing/video processing technology have been used for CSI compression, which can be natural choices considering the latest wave of ML applications in image processing/video processing. Further, when formulated in the right domain, CSI feedback bears similarities to images/video streams.

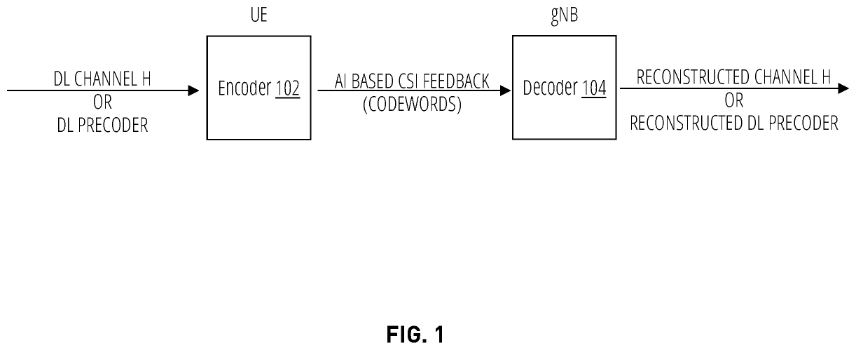

At a high level, FIG. 1 illustrates an encoder 102 of a UE and a decoder 104 of a base station (e.g., gNB) in an AI based CSI feedback operation according to certain embodiments. As shown, the encoder 102 receives a downlink (DL) channel H and outputs AI based CSI feedback. The encoder 102 learns a transformation from original transformation matrices to compressed representations (codewords) through training data. The decoder 104 learns an inverse transformation from the codewords to the original channels. Thus, the decoder 104 can receive the AI based CSI feedback (codewords) from the encoder 102 and output a reconstructed channel H. End-to-end learning (e.g., with an unsupervised learning algorithm) may be used to train the encoder 102 and the decoder 104. Typically, normalized mean square error (NMSE) or cosine similarity is the optimization metric. In some designs, the DL channel H can be replaced with DL precoder. Hence, the encoder 102 takes the DL precoder as input and generates AI based CSI feedback and the decoder 104 takes the AI based CSI feedback and reconstructs the DL precoder.

Various types of neural network (NN) encoders/decoders can be trained for different purposes, with different tradeoffs of complexity, overhead, and performance. A convolutional neural network (CNN) may, for example, be used for CSI feedback for frequency and spatial domain CSI reference signal (CSI-RS) compression. Other examples include using a transformer or a generative adversarial network (GAN). Depending on the number of receive antennas and rank, either channel feedback or precoding matrix indicator (PMI) feedback can be used. For example, with four receive antennas, rank 1 and rank 2 feedback may potentially use AI NN trained with an eigenvector as input, whereas rank 3 and rank 4 can potentially use channel state information as input to a trained AI NN. Data preprocessing can be used on input of an AI model. Preprocessing from frequency domain to time domain may be used and some of the small paths may be removed before input to the AI NN. A maximum rank indicates a maximum number of layers per UE, which corresponds to a lack of correlation or interference between the UE's antennas. For example, rank 1 corresponds to a maximum of one spatial layer for the UE, rank 2 corresponds to a maximum of two spatial layers for the UE, rank 3 corresponds to a maximum of three layers for the UE, and rank 4 corresponds to a maximum of four layers for the UE.

The input to the encoder 102 may include data without angle domain processing, which may be referred to as spatial domain projection (e.g., from 32 transmit ports to 8 spatial beams). Further, the input to the encoder 102 may include data without frequency domain (FD) processing (e.g., omitting the conversion from N₃ subbands to M taps or FD components). With or without angle domain processing, and with or without frequency domain processing, there are four combinations ({with angle domain processing, with frequency domain processing}, {with angle domain processing, without frequency domain processing}, {without angle domain processing, with frequency domain processing}, and {without angle domain processing, without frequency domain processing}). For the different combinations, the encoder 102 is fed with a two-dimensional (2D) matrix for a complex valued NN, or two 2D matrices (real part and imaginary part of the complex 2D matrix) for a real-valued NN.

Example use cases include spatial-frequency domain compression (which uses 3GPP Release (Rel)-16 or Rel-17 Type II codebook for comparison), and time-spatial-frequency domain compression or prediction. For time-spatial-frequency domain compression or prediction, if there are multiple channel matrices or precoding matrices at time t1, t2, t3, t4, . . . , then the auto encoder can be modified accordingly. For example, if the input data for a complex valued NN is a tensor of dimension N₄×Nₜₓ×N₃ (e.g., N₄=8 slots, Nₜₓ=32 transmit ports, and N₃=9 subbands), then the dimensions of relevant parts of the decoder, or decoder/encoder may be increased (e.g., instead of 2D convolution, three dimensional (3D) convolution is performed).

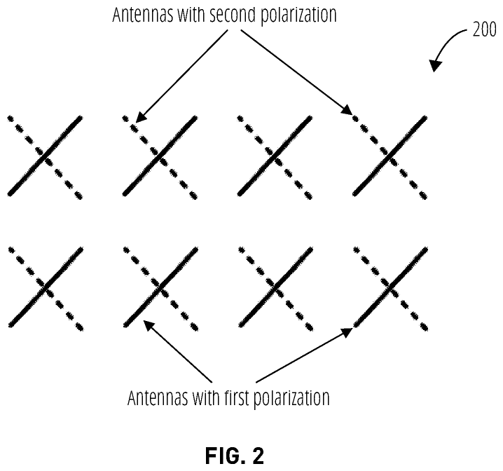

FIG. 2 illustrates an antenna configuration 200 that may be used, for example, at a base station according to certain embodiments. This example antenna configuration 200 includes antennas with a first polarization (shown in solid lines) and antennas with a second polarization (shown with dashed lines) arranged in two rows and four columns. Skilled persons will recognize from the disclosure herein that other antenna configurations may also be used with different numbers of rows, columns, and/or polarizations. Generally, the number of antenna ports is determined by the number of rows, the number of columns, and the number of polarizations. For AI and/or ML based approaches, a step for spatial basis selection can be omitted in certain designs (e.g., omitting the spatial beam projection) and a finer representation may be possible.

Rather than take advantage of a 2D antenna structure, such as the antenna configuration 200 shown in FIG. 2, certain designs (e.g., the paper by Chao-Kai Wen, et al., discussed above) use vectorization wherein a one dimensional (1D) vector is provided to the input of the ML encoder. However, embodiments disclosed herein provide NN architectures for CSI feedback based on antenna structure and configuration parameters to provide spatial-frequency domain compression, time-spatial-frequency domain compression, and time-spatial-frequency domain prediction. Compression embodiments (i.e., spatial-frequency domain compression or time-spatial-frequency domain compression) provide lower overhead feedback. Prediction embodiments mitigate degradation caused by channel aging by proactively predicting what could be the actual channel state at a future time when it is being used based on available observed channels.

The antenna structure and configuration parameters include N₁ number of antenna columns at the base station, N₂ number of antenna rows at the base station (or alternatively N₂ number of antenna columns at the base station, N₁ number of antenna rows at the base station), two polarizations for the base station antennas (e.g., −45° and +45°, or horizontal and vertical), and N₃ number of subbands for CSI feedback. In certain embodiments, for time-spatial-frequency domain compression and time-spatial-frequency domain prediction, the parameters also include N₄ number of occasions (e.g., slots) to generate N₃ precoders respectively for the N₃ subbands. For spatial-frequency domain compression, for example, N₄=1.

### Input Data Dimensions for Different NN Model Types

In certain embodiments, the base station's antenna structure and configuration parameters are used as input values to an NN model at an encoder of a UE to generate CSI feedback. Different NN model types are configured to receive and process different dimensions or combinations of the antenna structure and configuration parameters.

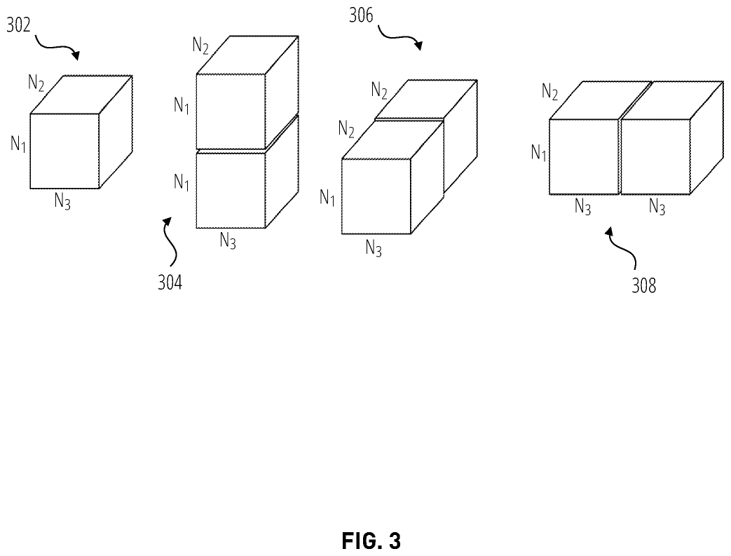

For example, FIG. 3 illustrates different dimensions of input data for various NN model types according to certain embodiments. A first input data option 302 comprises a 3D matrix or tensor corresponding to N₁ antenna columns in a first dimension, N₂ antenna rows in a second dimension, and N₃ subbands in a third dimension, or (N₁×N₂×N₃). Input data arranged as shown for the first input data option 302 may be provided to a NN model for each channel (e.g., polarization). For certain NN model types, however, the input data is concatenated along one of the dimensions (e.g., to input data for two polarizations at the same time). For example, a second input data option 304 comprises a 3D matrix or tensor corresponding to data stacked in the N₁ dimension for 2×N₁ antenna columns, N₂ antenna rows, and N₃ subbands (2·N₁×N₂×N₃). A third input data option 306 comprises a 3D matrix or tensor corresponding to data stacked in the N₂ dimension for N₁ antenna columns, 2×N₂ antenna rows, and N₃ subbands (N₁×2·N₂×N₃). A fourth input data option 308 comprises a 3D matrix or tensor corresponding to data stacked in the N₃ dimension for N₁ antenna columns, N₂ antenna rows, and 2×N₃ subbands (N₁×N₂×2·N₃). Although not shown in FIG. 3, a fourth dimension for each of the illustrated input data options (e.g., for time-spatial-frequency domain compression or prediction) may comprise the N₄ number of occasions.

### Spatial-Frequency Domain Compression (Complex Valued NN)

Complex valued NNs use a single channel for in-phase (I) and quadrature (Q) complex values. For spatial-frequency domain compression using a complex valued NN, data input to a first NN model type, referred to herein as spatial-frequency (SF) option 1 complex or SF-1c, corresponds to the first input data option 302 for N₁×N₂×N₃ with two channels (one channel for the first polarization and another channel for the second polarization).

For spatial-frequency domain compression using a complex valued NN, data input to a second NN model type, referred to herein as SF option 2 complex or SF-2c, corresponds to the second input data option 304 for 2·N₁×N₂×N₃ with one channel (including both polarizations).

For spatial-frequency domain compression using a complex valued NN, data input to a third NN model type, referred to herein as SF option 3 complex or SF-3c, corresponds to the third input data option 306 for N₁×2·N₂×N₃ with one channel (including both polarizations).

For spatial-frequency domain compression using a complex valued NN, data input to a fourth NN model type, referred to herein as SF option 4 complex or SF-4c, corresponds to the fourth input data option 308 for N₁×N₂×2·N₃ with one channel (including both polarizations). As multipath in the time domain induces frequency selectivity in the frequency domain, the disclosed input formulation applies also to spatial-delay domain compression, and N₃ in that setup takes the meaning of number of delay taps for the wireless channel.

### Spatial-Frequency Domain Compression (Real Valued NN)

Real valued NNs use separate channels for I and Q (I/Q) values. For spatial-frequency domain compression using a real valued NN, data input to a first NN model type, referred to herein as SF option 1 real or SF-1r, corresponds to the first input data option 302 for N₁×N₂×N₃ with four channels (two channels (I/Q) for the first polarization and two channels (I/Q) for the second polarization).

For spatial-frequency domain compression using a real valued NN, data input to a second NN model type, referred to herein as SF option 2 real or SF-2r, corresponds to the second input data option 304 for 2·N₁×N₂×N₃ with two channels (I/Q) (each including both polarizations).

For spatial-frequency domain compression using a real valued NN, data input to a third NN model type, referred to herein as SF option 3 real or SF-3r, corresponds to the third input data option 306 for N₁×2·N₂×N₃ with two channels (I/Q) (each including both polarizations).

For spatial-frequency domain compression using a real valued NN, data input to a fourth NN model type, referred to herein as SF option 4 real or SF-4r, corresponds to the fourth input data option 308 for N₁×N₂×2·N₃ with two channels (I/Q) (each including both polarizations). As multipath in the time domain induces frequency selectivity in the frequency domain, the disclosed input formulation applies also to spatial-delay domain compression, and N₃ in that setup takes the meaning of number of delay taps for the wireless channel.

### Example 3D CNN Auto Encoder

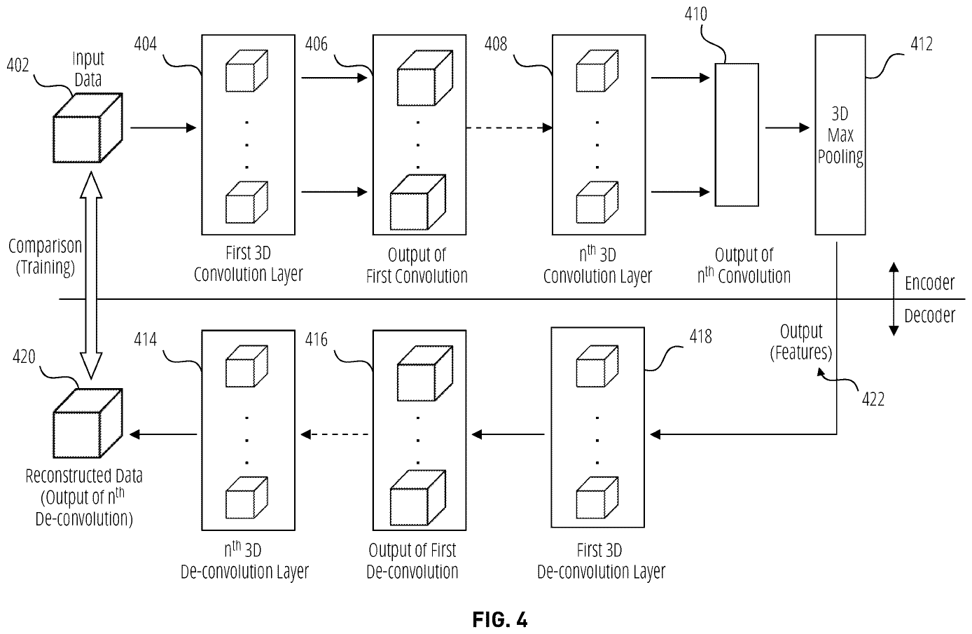

FIG. 4 is a block diagram illustrating, at a high level, an example 3D CNN auto encoder that may be used according to certain embodiments. See, for example, “Unsupervised Spatial-Spectral Feature Learning by 3D Convolutional Autoencoder for Hyperspectral Classification,” Shaohui Mei, et al., IEEE TRANSACTIONS ON GEOSCIENCE AND REMOTE SENSING, VOL. 57, NO. 9, September 2019. As shown, 3D input data 402 is provided to an encoder (shown above the horizontal line), which includes a first 3D convolution layer 404 that provides its output 406 to one or more subsequent layers until an n^{th} 3D convolution layer 408 provides its output 410 to a 3D max pooling layer 412 used for feature learning and configured to reduce the number of training parameters in the CNN.

The encoder output 422 (features) is provided to the decoder (shown below the horizontal line), which includes a first 3D de-convolution layer 418 that provides its output 416 to one or more subsequent layers until an n^{th} 3D de-convolution layer 414 provides reconstructed data 420. The reconstructed data 420 may be compared to the input data 402 (e.g., for training the CNN).

### Time-Spatial-Frequency Domain Compression/Prediction (Complex Valued NN)

Time-spatial-frequency domain compression and prediction use the N4 number of occasions with the examples shown in FIG. 3. Thus, for time-spatial-frequency domain compression using a complex valued NN, data input to a first NN model type, referred to herein as time-spatial-frequency (TSF) option 1 complex or TSF-1c, corresponds to the first input data option 302 with dimension N₄ for N₁×N₂×N₃×N₄ with two channels (one channel for the first polarization and another channel for the second polarization).

For time-spatial-frequency domain compression using a complex valued NN, data input to a second NN model type, referred to herein as TSF option 2 complex or TSF-2c, corresponds to the second input data option 304 with dimension N₄ for 2·N₁×N₂×N₃×N₄ with one channel (including both polarizations).

For time-spatial-frequency domain compression using a complex valued NN, data input to a third NN model type, referred to herein as TSF option 3 complex or TSF-3c, corresponds to the third input data option 306 with dimension N₄ for N₁×2·N₂×N₃×N₄ with one channel (including both polarizations).

For time-spatial-frequency domain compression using a complex valued NN, data input to a fourth NN model type, referred to herein as TSF option 4 complex or TSF-4c, corresponds to the fourth input data option 308 with dimension N₄ for N₁×N₂×2·N₃×N₄ with one channel (including both polarizations).

For time-spatial-frequency domain compression using a complex valued NN, data input to a fifth NN model type, referred to herein as TSF option 5 complex or TSF-5c, corresponds to the first input data option 302 with data concatenated in the N₄ dimension for N₁×N₂×N₃×2·N₄ with one channel (including both polarizations). As multipath in the time domain induces frequency selectivity in the frequency domain, the disclosed input formulation applies also to time-spatial-delay domain compression, and N₃ in that setup takes the meaning of number of delay taps for the wireless channel. By the duality between Doppler frequency and time-domain selectivity, the disclosed input formulation also applies to Doppler-spatial-frequency domain compression and Doppler-spatial-delay domain compression.

### Time-Spatial-Frequency Domain Compression/Prediction (Real Valued NN)

For time-spatial-frequency domain compression using a real valued NN, data input to a first NN model type, referred to herein as TSF option 1 real or TSF-1r, corresponds to the first input data option 302 with dimension N₄ for N₁×N₂×N₃×N₄ with four channels (two channels (real and imaginary parts) for the first polarization and two channels (real and imaginary parts) for the second polarization).

For time-spatial-frequency domain compression using a real valued NN, data input to a second NN model type, referred to herein as TSF option 2 real or TSF-2r, corresponds to the second input data option 304 with dimension N₄ for 2·N₁×N₂×N₃×N₄ with two channels (real and imaginary parts), each including both polarizations.

For time-spatial-frequency domain compression using a real valued NN, data input to a third NN model type, referred to herein as TSF option 3 real or TSF-3r, corresponds to the third input data option 306 with dimension N₄ for N₁×2·N₂×N₃×N₄ with two channels (real and imaginary parts), each including both polarizations.

For time-spatial-frequency domain compression using a real valued NN, data input to a fourth NN model type, referred to herein as TSF option 4 real or TSF-4r, corresponds to the fourth input data option 308 with dimension N₄ for N₁×N₂×2·N₃×N₄ with two channels (real and imaginary parts), each including both polarizations.

For time-spatial-frequency domain compression using a real valued NN, data input to a fifth NN model type, referred to herein as TSF option 5 real or TSF-5r, corresponds to the fourth input data option 308 with data concatenated in the N₄ dimension for N₁×N₂×N₃×2·N₄ with two channels (real and imaginary parts), each including both polarizations. As multipath in the time domain induces frequency selectivity in the frequency domain, the disclosed input formulation applies also to time-spatial-delay domain compression, and N₃ in that setup takes the meaning of number of delay taps for the wireless channel. By the duality between Doppler frequency and time-domain selectivity, the disclosed input formulation also applies to Doppler-spatial-frequency domain compression and Doppler-spatial-delay domain compression.

### Long Short-Term Memory NN

In certain embodiments, a long short-term memory (LSTM) NN may be used with 3D input data for time-frequency domain compression. A LSTM NN comprises feedback connections. For LSTM, one dimension can be treated as time. Also, with tensor flow, the data inputs to a LSTM NN can be 2D (ConvLSTM2 D layer) or 3D (ConvLSTM3D layer). Hence, LSTM with 2D can be also used for frequency domain compression treating the inputs with image at N₁×N₂ as a building block for further options. The time dimension for LSTM may be along N₃.

Thus, in certain embodiments, a LSTM architecture with 3D can be also used for time-frequency domain compression treating the inputs with image at N₁×N₂×N₃ as a building block, and further options may be available for a 4D auto encoder. The time dimension for LSTM may be along N₄. In addition, or in other embodiments, an input of N₁×N₂×N₄ may be used as a building block, with further options for a 4D auto encoder. The time dimension for LSTM is along N₃.

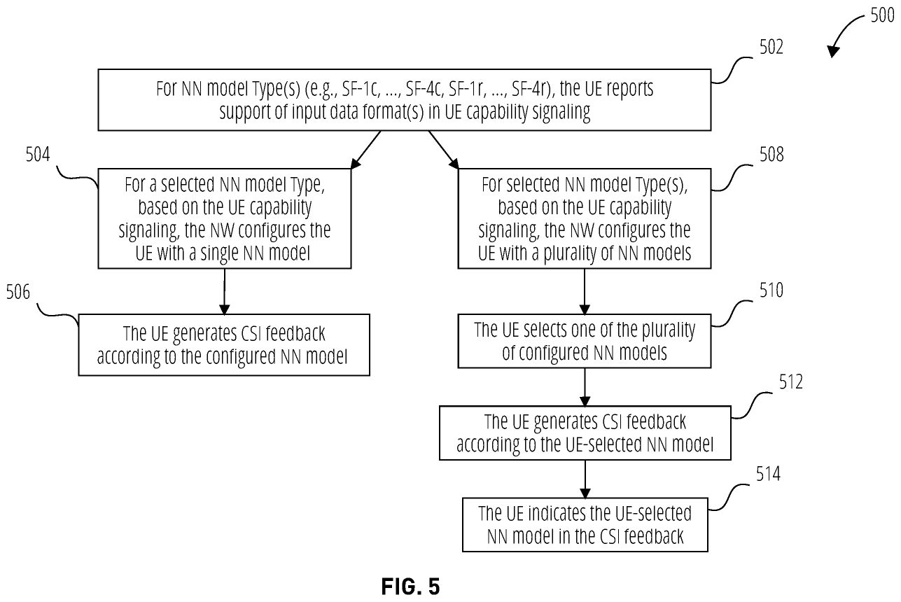

FIG. 5 is a flowchart illustrating a method 500 for ML based CSI feedback according to certain embodiments. At block 502, for one or more NN model type (e.g., SF-1c, . . . , SF-4c, SF-1r, . . ., SF-4r or other NN model types discussed herein), the UE reports support of input data format(s) in UE capability signaling.

In one embodiment, at block 504, for a selected NN model type, based on the UE capability signaling, the network (NW) configures the UE with a single NN model. At block 506, the UE then generates CSI feedback according to the configured NN model.

In another embodiment, at block 508, for one or more selected NN model type, based on the UE capability signaling, the NW configures the UE with a plurality of NN models. At block 510, the UE then selects one of the plurality of configured NN models. At block 512, the UE generates CSI feedback according to the UE-selected NN model. At block 514, the UE generates CSI feedback according to the UE-selected NN model.

FIG. 6 is a flowchart of a method 600 for a UE to provide ML based CSI to a wireless network according to one embodiment. In block 602, for one or more NN model type, the method 600 includes sending UE capability signaling to the wireless network to report one or more 3D or 4D input data format to a CSI feedback encoder. In block 604, for the one or more NN model type, the method 600 includes processing NN model configuration information from the wireless network. In block 606, the method 600 includes generating CSI feedback by providing DL channel data or DL precoder, formatted according to the one or more 3D or 4D input format, to an NN model corresponding to the NN model configuration information. In block 608, the method 600 includes sending the CSI feedback to the wireless network.

In certain embodiments of the method 600, the NN model configuration information corresponds only to the NN model selected by the wireless network.

In certain embodiments of the method 600, the NN model configuration information corresponds to a plurality of NN models, and the method 600 further comprises: selecting, by the UE, the NN model from among the plurality of NN models; and indicating, to the wireless network in the CSI feedback, the NN model selected by the UE.

In certain embodiments of the method 600, the one or more 3D or 4D input format includes at least a first dimension comprising N₁ number of antenna columns at a base station, a second dimension comprising N₂ number of antenna rows at the base station, and a third dimension comprising N₃ number of subbands for the CSI feedback.

In certain embodiments, the NN model comprises a complex valued NN for spatial-frequency domain compression, and the one or more 3D or 4D input format comprises N₁×N₂×N₃ with a first channel for a first polarization and a second channel for a second polarization.

In certain embodiments, the NN model comprises a complex valued NN for spatial-frequency domain compression, and the one or more 3D or 4D input format comprises 2·N₁×N₂×N₃ for one channel including two polarizations.

In certain embodiments, the NN model comprises a complex valued NN for spatial-frequency domain compression, and the one or more 3D or 4D input format comprises N₁×2·N₂×N₃ for one channel including two polarizations.

In certain embodiments, the NN model comprises a complex valued NN for spatial-frequency domain compression, and the one or more 3D or 4D input format comprises N₁×N₂×2·N₃ for one channel including two polarizations.

In certain embodiments, the NN model comprises a real valued NN for spatial-frequency domain compression, and the one or more 3D or 4D input format comprises N₁×N₂×N₃ with a first channel including in-phase (I) values for a first polarization, a second channel including the I values for a second polarization, a third channel including quadrature (Q) values for the first polarization, and a fourth channel including the Q values for the second polarization.

In certain embodiments, the NN model comprises a real valued NN for spatial-frequency domain compression, and the one or more 3D or 4D input format comprises 2·N₁×N₂×N₃ with a first channel including in-phase (I) values for two polarizations and a second channel including quadrature (Q) values for the two polarizations.

In certain embodiments, the NN model comprises a real valued NN for spatial-frequency domain compression, and the one or more 3D or 4D input format comprises N₁×2·N₂×N₃ with a first channel including in-phase (I) values for two polarizations and a second channel including quadrature (Q) values for the two polarizations.

In certain embodiments, the NN model comprises a real valued NN for spatial-frequency domain compression, and the one or more 3D or 4D input format comprises N₁×N₂×2·N₃ with a first channel including in-phase (I) values for two polarizations and a second channel including quadrature (Q) values for the two polarizations.

In certain embodiments of the method 600, the one or more 3D or 4D input format further includes N₄ number of occasions to generate precoders for the N₃ number of subbands.

In certain embodiments, the NN model comprises a complex valued NN for time-spatial-frequency domain compression or prediction, and the one or more 3D or 4D input format comprises N₁×N₂×N₃×N₄ with a first channel for a first polarization and a second channel for a second polarization.

In certain embodiments, the NN model comprises a complex valued NN for time-spatial-frequency domain compression or prediction, and the one or more 3D or 4D input format comprises 2·N₁×N₂×N₃×N₄ for one channel including two polarizations.

In certain embodiments, the NN model comprises a complex valued NN for time-spatial-frequency domain compression or prediction, and the one or more 3D or 4D input format comprises N₁×2·N₂×N₃×N₄ for one channel including two polarizations.

In certain embodiments, the NN model comprises a complex valued NN for time-spatial-frequency domain compression or prediction, and the one or more 3D or 4D input format comprises N₁×N₂×2·N₃×N₄ for one channel including two polarizations.

In certain embodiments, the NN model comprises a complex valued NN for time-spatial-frequency domain compression or prediction, and the one or more 3D or 4D input format comprises N₁×N₂×N₃×2·N₄ for one channel including two polarizations.

In certain embodiments, the NN model comprises a real valued NN for time-spatial-frequency domain compression or prediction, and the one or more 3D or 4D input format comprises N₁×N₂×N₃×N₄ with a first channel including real parts for a first polarization, a second channel including the real parts for a second polarization, a third channel including imaginary parts for the first polarization, and a fourth channel including the imaginary parts for the second polarization.

In certain embodiments, the NN model comprises a real valued NN for time-spatial-frequency domain compression or prediction, and the one or more 3D or 4D input format comprises 2·N₁×N₂×N₃×N₄ with a first channel including real parts for two polarizations and a second channel including imaginary parts for the two polarizations.

In certain embodiments, the NN model comprises a real valued NN for time-spatial-frequency domain compression or prediction, and the one or more 3D or 4D input format comprises N₁×2·N₂×N₃×N₄ with a first channel including real parts for two polarizations and a second channel including imaginary parts for the two polarizations.

In certain embodiments, the NN model comprises a real valued NN for time-spatial-frequency domain compression or prediction, and the one or more 3D or 4D input format comprises N₁×N₂×2·N₃×N₄ with a first channel including real parts for two polarizations and a second channel including imaginary parts for the two polarizations.

In certain embodiments, the NN model comprises a real valued NN for time-spatial-frequency domain compression or prediction, and the one or more 3D or 4D input format comprises N₁×N₂×N₃×2·N₄ with a first channel including real parts for two polarizations and a second channel including imaginary parts for the two polarizations.

In certain embodiments of the method 600, the NN model comprises a long short-term memory (LSTM) NN.

Embodiments contemplated herein include an apparatus comprising means to perform one or more elements of the method 600. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 600. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 902 that is a UE, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

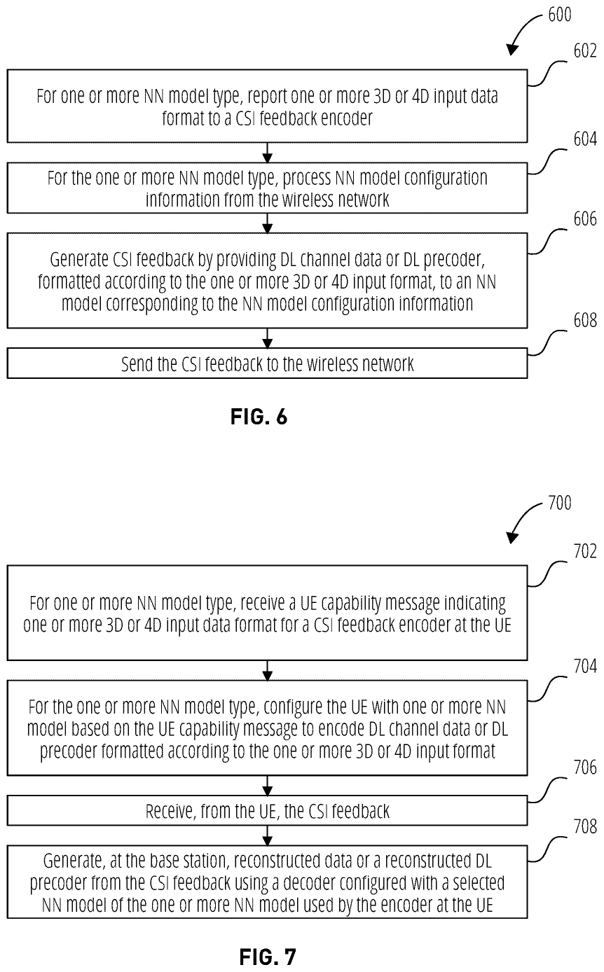

FIG. 7 is a flowchart of a method 700 for a base station to configure a UE with one or more NN model for CSI feedback according to one embodiment. In block 702, for one or more NN model type, the method 700 includes receiving a UE capability message indicating one or more 3D or 4D input data format for a CSI feedback encoder at the UE. In block 704, for the one or more NN model type, the method 700 includes configuring the UE with one or more NN model based on the UE capability message to encode DL channel data or DL precoder formatted according to the one or more 3D or 4D input format. In block 706, the method 700 includes receiving, from the UE, the CSI feedback. In block 708, the method 700 includes generating, at the base station, reconstructed data from the CSI feedback using a decoder configured with a selected NN model of the one or more NN model used by the encoder at the UE.

In certain embodiments of the method 700, configuring the UE with one or more NN model comprises configuring the UE with the selected NN model, and the selected NN model is selected by the base station.

In certain embodiments of the method 700, configuring the UE with one or more NN model comprises configuring the UE with a plurality of NN models, and the method 700 further comprises receiving, from the UE, an indication of the selected NN model in the CSI feedback.

In certain embodiments of the method 700, the one or more 3D or 4D input format includes at least a first dimension comprising N₁ number of antenna columns at a base station, a second dimension comprising N₂ number of antenna rows at the base station, and a third dimension comprising N₃ number of subbands for the CSI feedback.

In certain embodiments, the selected NN model comprises a complex valued NN for spatial-frequency domain compression, and the one or more 3D or 4D input format comprises N₁×N₂×N₃ with a first channel for a first polarization and a second channel for a second polarization.

In certain embodiments, the selected NN model comprises a complex valued NN for spatial-frequency domain compression, and the one or more 3D or 4D input format comprises 2·N₁×N₂×N₃ for one channel including two polarizations.

In certain embodiments, the selected NN model comprises a complex valued NN for spatial-frequency domain compression, and the one or more 3D or 4D input format comprises N₁×2·N₂×N₃ for one channel including two polarizations.

In certain embodiments, the selected NN model comprises a complex valued NN for spatial-frequency domain compression, and the one or more 3D or 4D input format comprises N₁×N₂×2·N₃ for one channel including two polarizations.

In certain embodiments, the selected NN model comprises a real valued NN for spatial-frequency domain compression, and the one or more 3D or 4D input format comprises N₁×N₂×N₃ with a first channel including in-phase (I) values for a first polarization, a second channel including the I values for a second polarization, a third channel including quadrature (Q) values for the first polarization, and a fourth channel including the Q values for the second polarization.

In certain embodiments, the selected NN model comprises a real valued NN for spatial-frequency domain compression, and the one or more 3D or 4D input format comprises 2·N₁×N₂×N₃ with a first channel including in-phase (I) values for two polarizations and a second channel including quadrature (Q) values for the two polarizations.

In certain embodiments, the selected NN model comprises a real valued NN for spatial-frequency domain compression, and the one or more 3D or 4D input format comprises N₁×2·N₂×N₃ with a first channel including in-phase (I) values for two polarizations and a second channel including quadrature (Q) values for the two polarizations.

In certain embodiments, the selected NN model comprises a real valued NN for spatial-frequency domain compression, and the one or more 3D or 4D input format comprises N₁×N₂×2·N₃ with a first channel including in-phase (I) values for two polarizations and a second channel including quadrature (Q) values for the two polarizations.

In certain embodiments of the method 700, the one or more 3D or 4D input format further includes N₄ number of occasions to generate precoders for the N₃ number of subbands.

In certain embodiments, the selected NN model comprises a complex valued NN for time-spatial-frequency domain compression or prediction, and the one or more 3D or 4D input format comprises N₁×N₂×N₃×N₄ with a first channel for a first polarization and a second channel for a second polarization.

In certain embodiments, the selected NN model comprises a complex valued NN for time-spatial-frequency domain compression or prediction, and the one or more 3D or 4D input format comprises 2·N₁×N₂×N₃×N₄ for one channel including two polarizations.

In certain embodiments, the selected NN model comprises a complex valued NN for time-spatial-frequency domain compression or prediction, and the one or more 3D or 4D input format comprises N₁×2·N₂×N₃×N₄ for one channel including two polarizations.

In certain embodiments, the selected NN model comprises a complex valued NN for time-spatial-frequency domain compression or prediction, and the one or more 3D or 4D input format comprises N₁×N₂×2·N₃×N₄ for one channel including two polarizations.

In certain embodiments, the selected NN model comprises a complex valued NN for time-spatial-frequency domain compression or prediction, and the one or more 3D or 4D input format comprises N₁×N₂×N₃×2·N₄ for one channel including two polarizations.

In certain embodiments, the selected NN model comprises a real valued NN for time-spatial-frequency domain compression or prediction, and the one or more 3D or 4D input format comprises N₁×N₂×N₃×N₄ with a first channel including real parts for a first polarization, a second channel including the real parts for a second polarization, a third channel including imaginary parts for the first polarization, and a fourth channel including the imaginary parts for the second polarization.

In certain embodiments, the selected NN model comprises a real valued NN for time-spatial-frequency domain compression or prediction, and the one or more 3D or 4D input format comprises 2·N₁×N₂×N₃×N₄ with a first channel including real parts for two polarizations and a second channel including imaginary parts for the two polarizations.

In certain embodiments, the selected NN model comprises a real valued NN for time-spatial-frequency domain compression or prediction, and the one or more 3D or 4D input format comprises N₁×2·N₂×N₃×N₄ with a first channel including real parts for two polarizations and a second channel including imaginary parts for the two polarizations.

In certain embodiments, the selected NN model comprises a real valued NN for time-spatial-frequency domain compression or prediction, and the one or more 3D or 4D input format comprises N₁×N₂×2·N₃×N₄ with a first channel including real parts for two polarizations and a second channel including imaginary parts for the two polarizations.

In certain embodiments, the selected NN model comprises a real valued NN for time-spatial-frequency domain compression or prediction, and the one or more 3D or 4D input format comprises N₁×N₂×N₃×2·N₄ with a first channel including real parts for two polarizations and a second channel including imaginary parts for the two polarizations.

In certain embodiments of the method 700, the selected NN model comprises a long short-term memory (LSTM) NN.

Embodiments contemplated herein include an apparatus comprising means to perform one or more elements of the method 700. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 700. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 918 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 920 of a network device 918 that is a base station, as described herein).

These instructions may be, for example, located in the processor and/or on a memory of the base station (such as a memory 922 of a network device 918 that is a base station, as described herein).

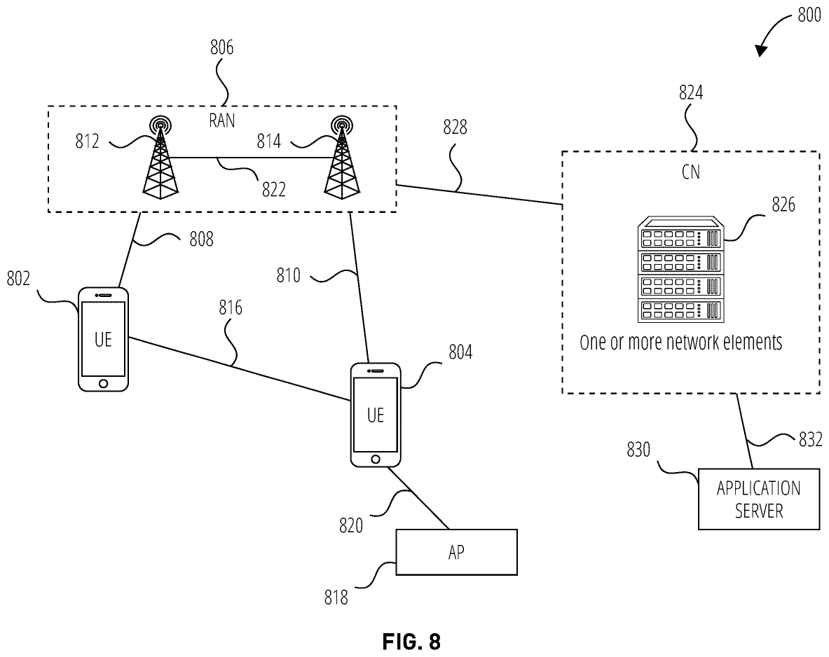

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822 In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an SI interface 828. In embodiments, the SI interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

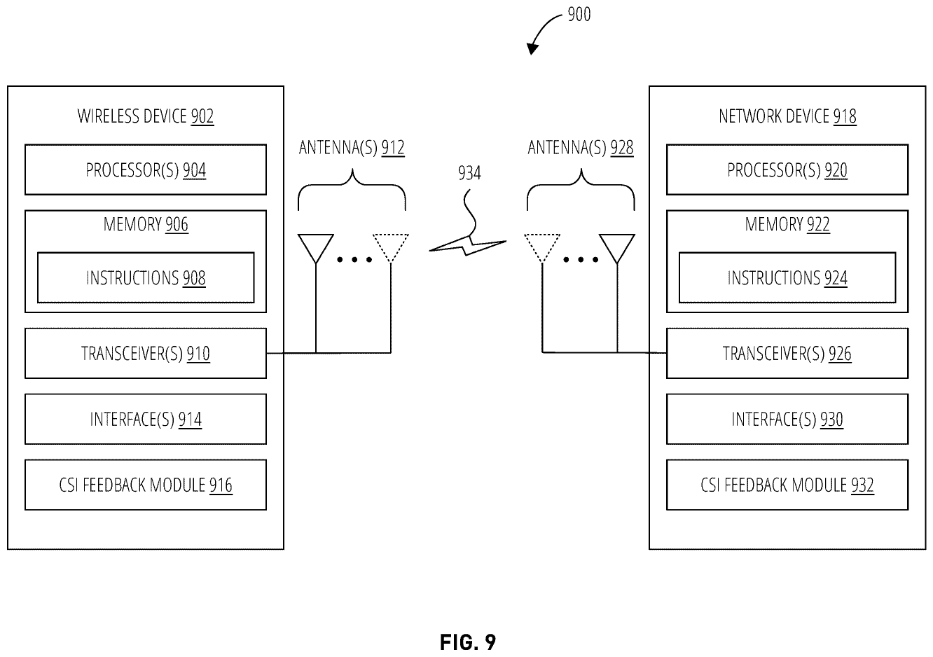

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single-user MIMO (SU-MIMO) methods (where the data streams are all directed to a single receiver) and/or multi-user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a CSI feedback module 916. The CSI feedback module 916 may be implemented via hardware, software, or combinations thereof. For example, the CSI feedback module 916 may be implemented as a processor, circuit, and/or instructions 908 stored in the memory 906 and executed by the processor(s) 904. In some examples, the CSI feedback module 916 may be integrated within the processor(s) 904 and/or the transceiver(s) 910. For example, the CSI feedback module 916 may be implemented by a combination of software components (e.g., executed by a DSP or a general processor) and hardware components (e.g., logic gates and circuitry) within the processor(s) 904 or the transceiver(s) 910.

The CSI feedback module 916 may be used for various aspects of the present disclosure, for example, aspects of FIG. 5 and FIG. 6. Further, the CSI feedback module 916 may include an encoder, such as the encoder 102 shown in FIG. 1 or the encoder shown in FIG. 4.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a CSI feedback module 932. The CSI feedback module 932 may be implemented via hardware, software, or combinations thereof. For example, the CSI feedback module 932 may be implemented as a processor, circuit, and/or instructions 924 stored in the memory 922 and executed by the processor(s) 920. In some examples, the CSI feedback module 932 may be integrated within the processor(s) 920 and/or the transceiver(s) 926. For example, the CSI feedback module 932 may be implemented by a combination of software components (e.g., executed by a DSP or a general processor) and hardware components (e.g., logic gates and circuitry) within the processor(s) 920 or the transceiver(s) 926.

The CSI feedback module 932 may be used for various aspects of the present disclosure, for example, aspects of FIG. 5 and FIG. 7. Further, the CSI feedback module 932 may include a decoder, such as the decoder 104 shown in FIG. 1 of the decoder shown in FIG. 4.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) to provide machine learning (ML) based channel state information (CSI) to a wireless network, the method comprising:
for one or more neural network (NN) model type, sending UE capability signaling to the wireless network to report one or more three dimensional (3D) or four dimensional (4D) input data format to a CSI feedback encoder;
for the one or more NN model type, processing NN model configuration information from the wireless network;
generating CSI feedback by providing downlink (DL) channel data or a DL precoder, formatted according to the one or more 3D or 4D input format, to an NN model corresponding to the NN model configuration information; and
sending the CSI feedback to the wireless network.

2·The method of claim 1, wherein the NN model configuration information corresponds only to the NN model selected by the wireless network.

3. The method of claim 1, wherein the NN model configuration information corresponds to a plurality of NN models, and wherein the method further comprises:
selecting, by the UE, the NN model from among the plurality of NN models; and
indicating, to the wireless network in the CSI feedback, the NN model selected by the UE.

4. The method of claim 1, wherein the one or more 3D or 4D input format includes at least a first dimension comprising N₁ number of antenna columns at a base station, a second dimension comprising N₂ number of antenna rows at the base station, and a third dimension comprising N₃ number of subbands for the CSI feedback.

5. The method of claim 4, wherein the NN model comprises a complex valued NN for spatial-frequency domain compression, and wherein the one or more 3D or 4D input format comprises N₁×N₂×N₃ with a first channel for a first polarization and a second channel for a second polarization.

6. The method of claim 4, wherein the NN model comprises a complex valued NN for spatial-frequency domain compression, and wherein the one or more 3D or 4D input format comprises 2·N₁×N₂×N₃ for one channel including two polarizations.

7. The method of claim 4, wherein the NN model comprises a complex valued NN for spatial-frequency domain compression, and wherein the one or more 3D or 4D input format comprises N₁×2·N₂×N₃ for one channel including two polarizations.

8. The method of claim 4, wherein the NN model comprises a complex valued NN for spatial-frequency domain compression, and wherein the one or more 3D or 4D input format comprises N₁×N₂×2·N₃ for one channel including two polarizations.

9. The method of claim 4, wherein the NN model comprises a real valued NN for spatial-frequency domain compression, and wherein the one or more 3D or 4D input format comprises N₁×N₂×N₃ with a first channel including in-phase (I) values for a first polarization, a second channel including the I values for a second polarization, a third channel including quadrature (Q) values for the first polarization, and a fourth channel including the Q values for the second polarization.

10. The method of claim 4, wherein the NN model comprises a real valued NN for spatial-frequency domain compression, and wherein the one or more 3D or 4D input format comprises 2·N₁×N₂×N₃ with a first channel including in-phase (I) values for two polarizations and a second channel including quadrature (Q) values for the two polarizations.

11. The method of claim 4, wherein the NN model comprises a real valued NN for spatial-frequency domain compression, and wherein the one or more 3D or 4D input format comprises N₁×2·N₂×N₃ with a first channel including in-phase (I) values for two polarizations and a second channel including quadrature (Q) values for the two polarizations.

12·The method of claim 4, wherein the NN model comprises a real valued NN for spatial-frequency domain compression, and wherein the one or more 3D or 4D input format comprises N₁×N₂×2·N₃ with a first channel including in-phase (I) values for two polarizations and a second channel including quadrature (Q) values for the two polarizations.

13. The method of claim 4, wherein the one or more 3D or 4D input format further includes N₄ number of occasions to generate precoders for the N₃ number of subbands.

14. The method of claim 13, wherein the NN model comprises a complex valued NN for time-spatial-frequency domain compression or prediction, and wherein the one or more 3D or 4D input format comprises N₁×N₂×N₃×N₄ with a first channel for a first polarization and a second channel for a second polarization.

15. The method of claim 13, wherein the NN model comprises a complex valued NN for time-spatial-frequency domain compression or prediction, and wherein the one or more 3D or 4D input format comprises 2·N₁×N₂×N₃×N₄ for one channel including two polarizations.

16. The method of claim 13, wherein the NN model comprises a complex valued NN for time-spatial-frequency domain compression or prediction, and wherein the one or more 3D or 4D input format comprises N₁×2·N₂×N₃×N₄ for one channel including two polarizations.

17. The method of claim 13, wherein the NN model comprises a complex valued NN for time-spatial-frequency domain compression or prediction, and wherein the one or more 3D or 4D input format comprises N₁×N₂×2·N₃×N₄ for one channel including two polarizations.

18. The method of claim 13, wherein the NN model comprises a complex valued NN for time-spatial-frequency domain compression or prediction, and wherein the one or more 3D or 4D input format comprises N₁×N₂×N₃×2·N₄ for one channel including two polarizations.

19. The method of claim 13, wherein the NN model comprises a real valued NN for time-spatial-frequency domain compression or prediction, and wherein the one or more 3D or 4D input format comprises N₁×N₂×N₃×N₄ with a first channel including real parts for a first polarization, a second channel including the real parts for a second polarization, a third channel including imaginary parts for the first polarization, and a fourth channel including the imaginary parts for the second polarization.

20. The method of claim 13, wherein the NN model comprises a real valued NN for time-spatial-frequency domain compression or prediction, and wherein the one or more 3D or 4D input format comprises 2·N₁×N₂×N₃×N₄ with a first channel including real parts for two polarizations and a second channel including imaginary parts for the two polarizations.

21-51. (canceled)
